(19) United States
(12) Patent Application Publication
(10) Pub. No.: US 2015/0180910 A1
(43) Pub. Date: Jun. 25, 2015

(54) COMMUNICATION NETWORK WITH LOW LATENCY CALL SIGNALING FUNCTIONALITY

(71) Applicant: Alcatel-Lucent Canada Inc., Ottawa (CA)

(72) Inventor: Jeroen van Bemmel, Calgary (CA)

(73) Assignee: Alcatel-Lucent Canada Inc., Ottawa (CA)

(21) Appl. No.: 14/133,923

(22) Filed: Dec. 19, 2013

(51) Int. Cl. H04L 29/06

(52) U.S. Cl. CPC H04L 65/1069

(57) ABSTRACT

A method includes sending substantially simultaneously two or more session requests from a first processing device respectively to two or more groups of virtual resources of a communication network, wherein the two or more groups of virtual resources represent two or more paths to a second processing device, such that a single session can be established between a first user and a second user based on one of the two or more session requests.

### FIELD

The application relates generally to communication networks, and more particularly to communication protocols implementing call signaling functionality.

### BACKGROUND

One type of communication network gaining popularity is a cloud network. The term “cloud” refers to a collective computing infrastructure that implements a cloud computing paradigm. For example, as per the National Institute of Standards and Technology (NIST Special Publication No. 800-145), cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction.

Cloud computing implements the computing concept known as “virtualization.” Virtualization generally allows virtual machines (VMs) to run on a single physical machine, with each VM sharing the resources of that one physical machine. Thus, VMs are logical processing elements that are instantiated on one or more physical processing elements (e.g., servers, computers, processing devices, and the like). Virtualization may be implemented by inserting a layer of software, called a virtual machine monitor or a hypervisor, directly on the computer hardware. The hypervisor allocates hardware resources (e.g., physical storage resources and physical computing resources) of the physical computer dynamically and transparently. The hypervisor thus affords the ability for multiple operating systems to run concurrently on a single physical computer and share hardware resources with each other.

As is known, latency outliers are a key phenomenon in cloud networks. Due to virtualization of resources and variance in memory and disk access times, some individual requests submitted to a cloud network may take significantly longer to be serviced than average. This can be a significant problem when a service provider has to meet service level agreements (SLAs) for customers; such as in reliable telecommunication services, and call signaling in particular. Moreover, the trend of moving from physical machines to cloud environments presents availability and redundancy issues. This is at least in part because, in a cloud environment, failure modes are different and traditional hardware redundancy is often no longer possible.

### SUMMARY

Illustrative embodiments of the invention provide low latency call signaling techniques for use in a communication network. While embodiments are applicable to varied types of communication networks, one or more embodiments are particularly well-suited for use in a cloud network.

In one embodiment, a method comprises sending substantially simultaneously two or more session requests from a first processing device respectively to two or more groups of virtual resources of a communication network, wherein the two or more groups of virtual resources represent two or more paths to a second processing device, such that a single session can be established between a first user and a second user based on one of the two or more session requests.

Advantageously, illustrative embodiments of the invention reduce or eliminate, at least, the above-mentioned issues of latency outliers, availability, and redundancy.

These and other features and advantages of the present invention will become more apparent from the accompanying drawings and the following detailed description.

### BRIEF DESCRIPTION OF THE DRAWINGS

FIG. 1 shows a communication network environment in which one or more embodiments of the invention are implemented.

FIG. 2 shows a parallel call methodology according to an embodiment of the invention.

FIG. 3 shows further details of a parallel call methodology according to an embodiment of the invention.

FIG. 4 shows a parallel call methodology according to another embodiment of the invention.

### DETAILED DESCRIPTION

Illustrative embodiments of the invention will be described herein with reference to exemplary communication networks, user devices, network nodes, and associated communication protocols. It should be understood, however, that embodiments of the invention are not limited to use with the particular arrangements described, but are instead more generally applicable to any communication network application in which it is desirable to provide improved performance by providing low latency call signaling functionality.

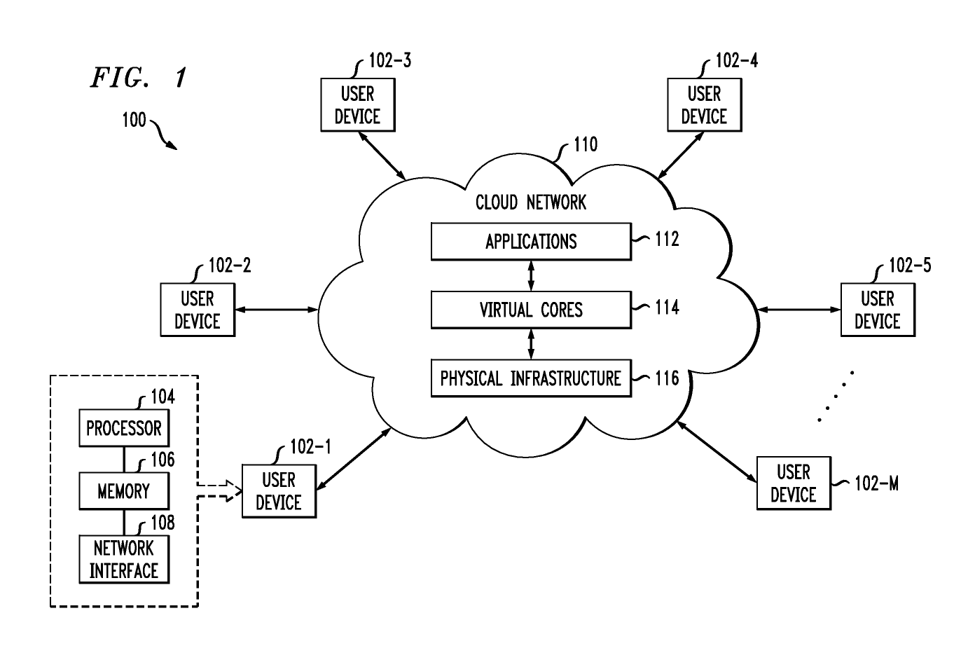

FIG. 1 shows a communication network environment 100 in which one or more embodiments of the invention are implemented. More particularly, as shown, a plurality of user devices 102-1 through 102-M are connected to a cloud network 110. The user devices may, for example, be mobile user devices (e.g., smartphones, laptops, and/or other typically mobile computing or processing devices), fixed user devices (e.g., desktops, servers, and/or other typically non-mobile computing or processing devices), or combinations thereof.

Each user device 102 (as shown, by way of example, for user device 102-1) comprises a processor 104, a memory 106, and a network interface 108, operatively coupled to one another. It is assumed that the processor 104 is configured to direct the operation of the corresponding user device 102 by executing software that is stored in the memory 106. The network interface 108 includes network interface circuitry to allow the user device 102 to communicate with the cloud network 110, and thus with one or more other user devices 102. Such network interface circuitry includes one or more conventional transceivers as well as other related circuitry used to support communication and other protocols mentioned herein.

The processor 104 may be implemented utilizing a microprocessor, a microcontroller, an application-specific integrated circuit (ASIC), a field-programmable gate array (FPGA), or other type of processing circuitry, as well as portions or combinations of such processing circuitry. A given such processor may include one or more embedded memories as internal memories. As indicated above, the processor 104 and any associated internal or external memory may be used in storage and execution of one or more software programs for controlling the operation of the corresponding user device 102.

The memory 106 may include one or more storage areas that may be utilized for program code storage. The memory 106 may therefore be viewed as an example of what is more generally referred to herein as a processor or computer-readable storage medium that has executable program code embodied therein. Other examples of computer-readable storage media may include disks or other types of magnetic or optical media, in any combination. Articles of manufacture comprising such computer-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

The memory 106 may more particularly comprise, for example, an electronic random access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The processor 104, memory 106, network interface 108, and other components of a given user device of communication network 100 may include well-known circuitry suitably modified to implement at least a portion of the low latency call signaling functionality described herein. Conventional aspects of such circuitry are well known to those skilled in the art and therefore will not be described in detail herein.

As further shown in FIG. 1, cloud network 110 includes applications 112, virtual cores 114, and physical infrastructure 116, operatively coupled to one another. The phrase “virtual cores,” as used herein is intended to generally refer to groups of virtual computing resources. Analogous to physical processor cores in a multi-core processing architecture where each physical processor core includes its own central processing unit (CPU) or processor, associated memory, and other supporting circuitry, a virtual core is a designated grouping of virtual resources, i.e., one or more VMs and/or one or more logical storage units (LUNs). Virtual cores 114 are managed by a hypervisor (assumed to be part of layer 114) which allocates each available virtual core to satisfy the demands of a given application 112.

The physical infrastructure 116 may include, by way of example only, servers, computers, processing devices, storage arrays, and other physical computing and/or storage resources. It is to be appreciated that the same or a similar computing architecture (i.e., processor, memory, network interface, etc.) as that shown in FIG. 1 for user device 102, and as described above, can be used to implement the physical resources of physical infrastructure 116.

By way of one example, one of the applications (112) in cloud network 110 may include a Voice-over-Internet Protocol (VoIP) application. A VoIP application delivers voice communications and multimedia sessions over Internet Protocol (IP) networks, such as the Internet.

In one illustrative embodiment, cloud network 110 implements an IP Multimedia Subsystem (IMS). As set forth in accordance with the 3^{rd} Generation Partnership Project (3GPP) or 3GPP2, IMS provides access-agnostic architecture for converged networks. Service providers utilize this architecture in next-generation network evolution to provide multimedia services to mobile users and also fixed access users. IMS uses IP and, more specifically, uses Session Initiation Protocol (SIP) as the call control protocol. SIP is described in the Internet Engineering Task Force (IETF) Request for Comments (RFC) 3261, “SIP: Session Initiation Protocol,” June 2002, which is incorporated by reference herein.

More specifically, SIP is an application-layer signaling protocol used for establishing communication sessions in an IP network. It can be used to create, modify and terminate sessions, which may include, for example, IP telephone calls or collaborative multimedia conferences.

A session may be considered an exchange of data between a group of two or more participants, also referred to as users. The users are associated with endpoints that are referred to as user agents (e.g., user devices 102 in FIG. 1). SIP allows user agents to discover one another and to agree on a characterization of a session they would like to share. Sessions are created using SIP invite messages that carry session descriptions that allow the users to agree on a set of compatible media types. SIP also enables the creation of an infrastructure of network hosts, called proxy servers, to which user agents can send invite messages and other requests. For example, SIP provides a registration function that allows users to upload their current locations for use by proxy servers. SIP works independently of underlying transport protocols and without dependency on the type of session that is being established.

Recall, as mentioned above in the background section, that traditional cloud networks are susceptible to request latency as well as availability and redundancy issues. Traditional IMS-based cloud networks are no exception. A traditional IMS solution typically uses hardware redundancy (active/active or active/standby) combined with protocols such as Virtual Router Redundancy Protocol (VRRP) for reliability. In the active/active scenario, traffic intended for a failed node in the network is either passed on to an existing active node or load balanced across the remaining active nodes. In the active/standby scenario, traffic intended for a failed node in the network is passed on to a standby (previously non-active) node. These scenarios are usually only possible when the nodes utilize a homogeneous software configuration. However, such a traditional solution typically requires specific special hardware which is not available in cloud environments. Further, such a traditional solution ties software to hardware which goes against the flexible design principles of the cloud computing paradigm.

Availability in a cloud network can be improved by providing redundancy at the software level, e.g., by executing active/standby instances of selected components. However, in such designs, redundant components are used serially for any given call attempt (i.e., first try primary component; upon timeout, try secondary component) which leads to delays, and does nothing to reduce the average latency of all call attempts.

IFTF RFC 5626, “Managing Client-Initiated Connections in Session Initiation Protocol (SIP),” October 2009, which is incorporated by reference herein, discloses parallel registrations with multiple registrars to support redundancy. However, the user agent serving as the caller is required to pick one flow for making a call.

In order to overcome these and other problems with traditional solutions, methodologies are provided, in accordance with embodiments of the invention, which support parallel call attempts by a user agent. For example, in a cloud network environment, independent redundant instances of core functions are used, i.e., two or more such instances are utilized in parallel. Then, the first path (virtual core) that succeeds is selected, while the other attempt(s) are aborted.

In one illustrative embodiment, two or more WebRTC clients are implemented using Javascript register with two independent SIP registrars/cores (3GPP IMS or other) following RFC 5626 procedures. Note that WebRTC is an open source project that enables web browsers with Real-Time Communications (RTC) capabilities via simple JavaScript application programming interfaces (APIs).

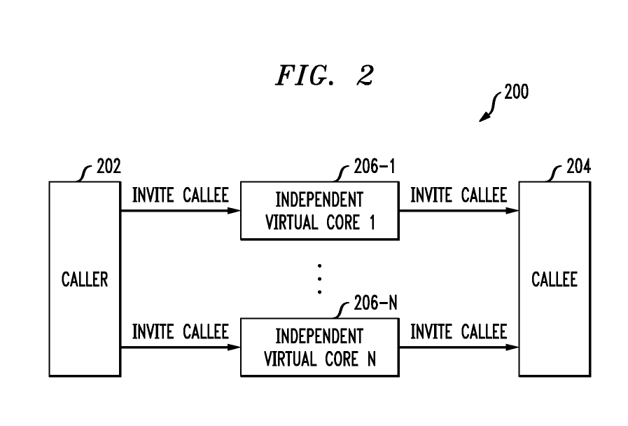

FIG. 2 shows an example implementation 200 of this parallel call attempt (i.e., low latency call signaling) methodology. Caller 202 and callee 204 represent respective WebRTC user agents (user devices 102 in FIG. 1). The “caller” is the initiating user agent (client) for a VoIP call session, while the “callee” is the receiving user agent (client) of the call. As shown, N parallel call requests (INVITE callee) are sent to N (where N is 2 or greater) virtual cores 206-1 through 206-N, respectively. Recall that a virtual core is a designated grouping of virtual resources, i.e., one or more VMs and/or one or more LUNs, managed by a hypervisor which allocates each available virtual core to satisfy the demands of a given application (in this case, a VoIP application). The virtual cores are independent of one another. However, in other alternative embodiments, it is possible that a subset of virtual resources may be shared by two virtual cores. Note that the N multiple call requests (call session requests) are sent simultaneously, substantially simultaneously, or contemporaneously from the caller. The N call requests are sent from the caller prior to receiving a response related to any of the N call requests.

While embodiments of the invention are not so limited, it is assumed in the example below that there are two independent virtual cores (i.e., N=2). According to this example, when a user directs a user agent (caller) to set up a new call to another user agent (callee), the user agent sends out two standard SIP INVITE requests to two virtual cores. A standard SIP INVITE request is sent to each of two respective virtual cores. The messages follow standard SIP call processing procedures, and both arrive at the callee. The callee responds to both requests again using standard SIP signaling, and alerts its user of an incoming call attempt (single alert for both attempts). When the user accepts (both attempts are accepted), the caller replies to the first one to arrive with a standard acknowledgement, and to the other attempts with an acknowledgement marked as ‘aborted’ (which represents a new SIP extension). Alternatively, the caller could use standard SIP messages ACK and BYE to abort all but the first attempt to receive a reply.

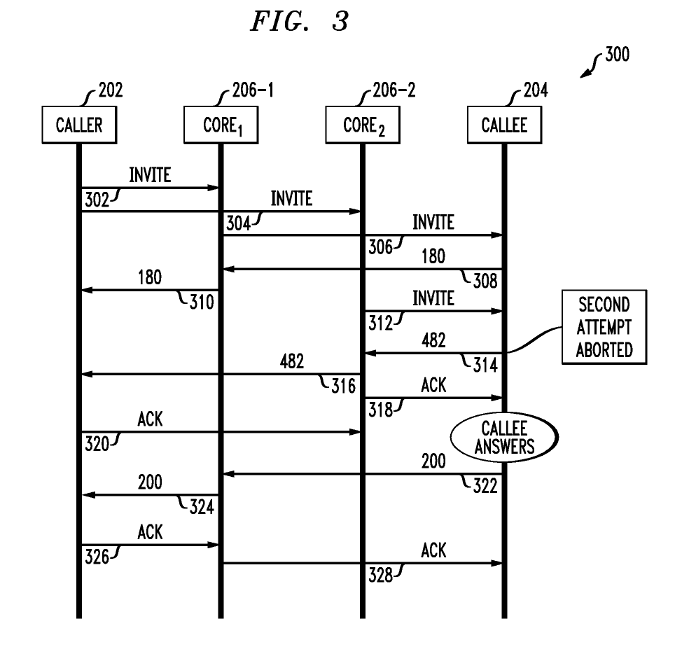

FIG. 3 shows further details of an example of the SIP call signaling. Call flow 300 proceeds as follows. In steps 302 and 304, caller 202 sends out two standard SIP INVITE requests to virtual core 206-1 and virtual core 206-2, respectively. The SIP INVITE requests are sent from the virtual cores to the callee 204. In this example, it is assumed that virtual core 206-1 forwards the INVITE request to callee 204 and/or the INVITE request from core 206-1 is received by callee 204 in step 306 before virtual core 206-2 forwards the INVITE request to callee 204 and/or the INVITE from core 206-2 is received by callee 204 in step 312. As such, callee 204 responds to virtual core 206-1 in step 308 with a SIP message 180 (indicating to recipient that the callee received the INVITE and is alerting the user of the call, i.e., ringing). Virtual core 206-1 forwards the SIP message 180 to caller 202 in step 310.

Callee 204 aborts the second call attempt and, in step 314, sends virtual core 206-2 a SIP message 482 that is marked ‘aborted.’ Virtual core 206-2 forwards the 482 message to caller 202 in step 316 to indicate that the second call attempt has been aborted. Virtual core 206-2 acknowledges (ACK message) receipt of the abort message to callee 204 in step 318. Caller 202 acknowledges (ACK message) receipt of the abort message to virtual core 206-2 in step 320.

Callee 204 answers the first call request, through virtual core 206-1, via the standard SIP message 200 and ACK message exchange in step 322, 324, 326 and 328.

It is to be appreciated that the call flow of FIG. 3 is one example of a call flow and, thus, other call flows that implement the parallel call methodology of FIG. 2 may be realized by those of ordinary skill in the art in a straightforward manner based on the teachings provided herein.

In an alternative embodiment, edge gateways (e.g., session border controllers (SBCs)) on both caller and callee sides perform the parallel routing of incoming requests, shielding the caller and callee from signaling beyond the standard messages of a single call. This deployment model may be used for user devices (user agents/clients) that do not support the parallel call approach described herein.

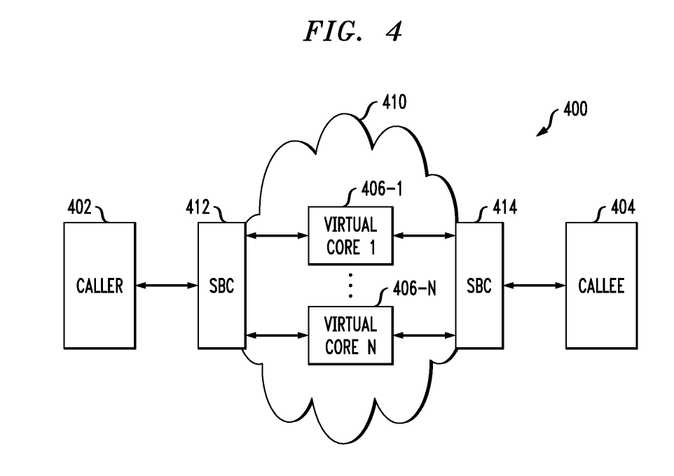

FIG. 4 shows an edge gateway example 400 with caller 402, callee 404, virtual cores 406-1 through 406-N in cloud network 410, and a pair of SBCs 412 and 414. As shown in implementation 400, caller 402 sends out a single call request which is received by caller-side SBC 412. Note on the callee-side, callee 404 is coupled to SBC 414. According to the principles of the invention, SBC 412 creates multiple redundant requests from the single request received from caller 402 and sends them toward callee 404 through the parallel virtual cores 406-1 through 406-N. SBC 414 receives the parallel call requests. SBCs 412 and 414 then perform all or parts of the call signaling protocol shown in FIG. 3 in order to establish a call between caller 402 and callee 404. Thus, the user devices need not be configured to perform the parallel call signaling methodology to receive the benefits described herein.

It is to be appreciated that the same or a similar computing architecture (i.e., processor, memory, network interface, etc.) as that shown in FIG. 1 for user device 102, and as described above, can be used to implement the SBCs 412 and 414. It is to be further appreciated that the user devices, physical infrastructure, SBCs, and other computing/processing components mentioned herein may be, more generally, referred to as “computing devices” or “processing devices.”

Advantageously, as described herein, the active use of multiple independent paths for signaling results in lower average call setup latencies, because the fastest response is used. This methodology also improves robustness against failures; either path can fail completely without impacting the call setup. The use of embodiments of the invention allows individual signaling cores to be implemented as sets of single instances of VMs, simplifying the design and reducing the chance of software design errors.

Illustrative embodiments improve the reliability of cloud-based signaling applications using software-only techniques that are aligned with cloud principles. They reduce the occurrence of latency outliers, making the complete system more robust, stable and constant in performance while simplifying the implementation of core functions. This, in turn, allows core functions to be moved around more easily, in support of elasticity requirements and allowing for optimized resource usage.

Although certain illustrative embodiments are described herein in the context of communication networks utilizing particular communication protocols such as IP, IMS and SIP, other types of networks can be used in other embodiments. As noted above, the term “network” as used herein is therefore intended to be broadly construed. Further, it should be emphasized that the embodiments described above are for purposes of illustration only, and should not be interpreted as limiting in any way. Other embodiments may use different types of network, device and module configurations, and alternative communication protocols, process steps and operations for implementing call signaling functionality. The particular manner in which the user devices and network nodes communicate can be varied in other embodiments. Also, it should be understood that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

What is claimed is:

1. A method, comprising:
sending substantially simultaneously two or more session requests from a first processing device respectively to two or more groups of virtual resources of a communication network, wherein the two or more groups of virtual resources represent two or more paths to a second processing device, such that a single session can be established between a first user and a second user based on one of the two or more session requests.

2. The method of claim 1, further comprising receiving at the first processing device an acknowledgement that one of the two or more session requests is successful.

3. The method of claim 1, further comprising receiving at the first processing device an indication that remaining ones of the two or more session requests are unsuccessful.

4. The method of claim 1, wherein the two or more session requests are call session requests such that the first user represents a caller and the second user represents a callee.

5. The method of claim 1, wherein the two or more groups of virtual resources comprise respective virtual cores.

6. The method of claim 1, wherein the first processing device comprises a first user device and the second processing device comprises a second user device.

7. The method of claim 1, wherein the first processing device comprises a first network controller and the second processing device comprises a second network controller.

8. The method of claim 7, wherein the first network controller and the second network controller comprise session border controllers.

9. The method of claim 1, wherein the communication network comprises an Internet Protocol Multimedia Subsystem.

10. The method of claim 9, wherein messages sent between the first processing device, the two or more groups of virtual resources, and the second processing device are formatted in accordance with a Session Initiation Protocol.

11. The method of claim 1, wherein the two or more paths to the second processing device are independent of one another.

12. An article of manufacture comprising a processor-readable storage medium excluding signals and having embodied therein executable program code that when executed by a processor of the first processing device causes the first processing device to perform the method of claim 1.

13. An apparatus, comprising:
a memory; and
a processor operatively coupled to the memory to form a first processing device configured to send substantially simultaneously two or more session requests respectively to two or more groups of virtual resources of a communication network, wherein the two or more groups of virtual resources represent two or more paths to a second processing device, such that a single session can be established between a first user and a second user based on one of the two or more session requests.

14. The apparatus of claim 13, wherein the first processing device is further configured to receive an acknowledgement that one of the two or more session requests is successful.

15. The apparatus of claim 13, wherein the first processing device is further configured to receive an indication that remaining ones of the two or more session requests are unsuccessful.

16. The apparatus of claim 13, wherein the two or more session requests are call session requests such that the first user represents a caller and the second user represents a callee.

17. The apparatus of claim 13, wherein the two or more groups of virtual resources comprise respective virtual cores.

18. The apparatus of claim 13, wherein the first processing device comprises a first user device and the second processing device comprises a second user device.

19. The apparatus of claim 13, wherein the first network controller and the second network controller comprise network controllers or session border controllers.

20. The apparatus of claim 13, wherein the communication network comprises an Internet Protocol Multimedia Subsystem.

21. The apparatus of claim 20, wherein messages sent between the first processing device, the two or more groups of virtual resources, and the second processing device are formatted in accordance with a Session Initiation Protocol.

22. The apparatus of claim 13, wherein the two or more paths to the second processing device are independent of one another.

23. A communication system, comprising:
a first virtual core; and
at least a second virtual core;
wherein the first virtual core and the at least a second virtual core are operatively coupled between a first user device and a second user device, and are configured to receive a first session request and at least a second session request, respectively, from the first user device, wherein the first virtual core and the at least a second virtual core represent respective paths from the first user device to the at least a second user device, such that a single session can be established between a first user and a second user based on one of the first session request and the at least a second session request which is first received.
